(19) United States
(12) Patent Application Publication
(10) Pub. No.: US 2025/0234379 A1
(43) Pub. Date: Jul. 17, 2025

(54) WIRELESS COMMUNICATION DEVICE, WIRELESS COMMUNICATION METHOD, AND WIRELESS COMMUNICATION SYSTEM

(71) Applicant: NIPPON TELEGRAPH AND TELEPHONE CORPORATION, Tokyo (JP)

(72) Inventors: Shoko SHINOHARA, Musashino-shi, Tokyo (JP); Yusuke ASAI, Musashino-shi, Tokyo (JP); Yoshitaka SHIMIZU, Musashino-shi, Tokyo (JP); Junichi IWATANI, Musashino-shi, Tokyo (JP); Tomoyuki YAMADA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/854,074

(22) PCT Filed: Apr. 14, 2022
(86) PCT No.: PCT/JP2022/017838

§ 371 Date: Oct. 4, 2024

(51) Int. Cl. H04W 74/0816; H04W 24/08

(52) U.S. Cl. CPC H04W 74/0816; H04W 24/08

(57) ABSTRACT

The present disclosure relates to a wireless communication device, a wireless communication method, and a wireless communication system which perform communication between a plurality of wireless modules. The wireless communication device includes: a plurality of wireless modules; and a control circuit, in which: the wireless modules have a function of performing wireless communication, a function of monitoring a total transmission time of the wireless communication per certain observation period, and a function of limiting the wireless communication when the total transmission time reaches a certain time; and the control circuit has a function of determining a different start timing of the observation period for each wireless module.

### TECHNICAL FIELD

The present disclosure relates to a wireless communication device, a wireless communication method, and a wireless communication system, and particularly relates to a wireless communication device, a wireless communication method, and a wireless communication system which perform communication between a plurality of wireless modules.

### BACKGROUND ART

In the field of wireless communication, there has been conventionally known a method of relaying a wireless signal by using a repeater or the like to expand an area. For example, in a case where two wireless modules provided in the repeater communicate with terminals in different areas, a relay between two areas can be performed by transferring a packet received in the repeater.

Here, in order to use the two wireless modules in the same housing, it is necessary to avoid wireless interference. Examples to be avoided include a reception failure occurring when one wireless module transmits a signal while the other wireless module is receiving a signal, a collision of received signals occurring when both wireless areas are hidden terminals, and a transmission failure occurring when both the wireless modules simultaneously transmit signals.

Frequency or time division is known as avoiding means. As the frequency division, for example, there is known a method in which each wireless module uses sufficiently separate frequency channels to completely avoid the above collision of wireless signals. As the time division, there is known an avoiding method using a limitation of a total transmission time called duty limit.

### CITATION LIST

### Non Patent Literature

Non Patent Literature 1: IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications

### SUMMARY OF INVENTION

### Technical Problem

However, in the conventional frequency division, in a case where the number of available frequency channels is small, a plurality of channels having sufficiently separate frequencies cannot be prepared. In this case, overlapping or adjacent channels are used, but each module performs carrier sensing only in a channel used by its own terminal, and thus communication using an adjacent channel out of the range cannot be detected. Then, communication proceeds as set, and thus power leaking from the adjacent channel collides with a transmitted wireless signal.

In order to solve the above problem, the present disclosure shifts a start timing of a period in which a total transmission time is monitored between a plurality of wireless modules arranged in the same housing or extremely close to each other so as to comply with the duty limit. Alternatively, the present disclosure shifts the start timing of the period in which the total transmission time is monitored between terminal groups communicating with the respective wireless modules. Therefore, an object thereof is to provide a wireless communication system capable of avoiding a collision of wireless signals.

### Solution to Problem

A first aspect of the present disclosure is preferably a wireless communication device including: a plurality of wireless modules; and a control circuit, in which: the wireless modules have a function of performing wireless communication, a function of monitoring a total transmission time of the wireless communication per certain observation period, and a function of limiting the wireless communication when the total transmission time reaches a certain time; and the control circuit has a function of determining a different start timing of the observation period for each wireless module.

A second aspect of the present disclosure is preferably a wireless communication method, in which: a plurality of wireless modules performs processing of performing wireless communication, processing of monitoring a total transmission time of the wireless communication per certain observation period, and processing of limiting the wireless communication when the total transmission time reaches a certain time; and the control circuit performs processing of determining a start timing of the observation period.

A third aspect of the present disclosure is preferably a wireless communication system including: a plurality of wireless module units that performs wireless communication, monitors a total transmission time of the wireless communication per certain observation period, and limits the wireless communication when the total transmission time reaches a certain time; and a control unit that determines a start timing of the observation period.

### Advantageous Effects of Invention

According to the first to third aspects of the present disclosure, it is possible to provide a wireless communication device, a wireless communication method, and a wireless communication system capable of avoiding a collision of wireless signals by distributing time periods in which traffic is concentrated.

### BRIEF DESCRIPTION OF DRAWINGS

FIG. 1 shows wireless communication timings of a plurality of wireless modules in the same housing according to a first conventional example.

FIG. 2 shows wireless communication timings of a plurality of wireless modules in the same housing according to a second conventional example.

FIG. 3 shows a configuration of a wireless communication system according to a first embodiment of the present disclosure.

FIG. 4 shows a configuration of a wireless communication repeater of the present disclosure.

FIG. 5 shows an observation period according to the first embodiment.

FIG. 6 shows a start timing of observation in a plurality of wireless modules according to the first embodiment.

### DESCRIPTION OF EMBODIMENTS

### First Embodiment

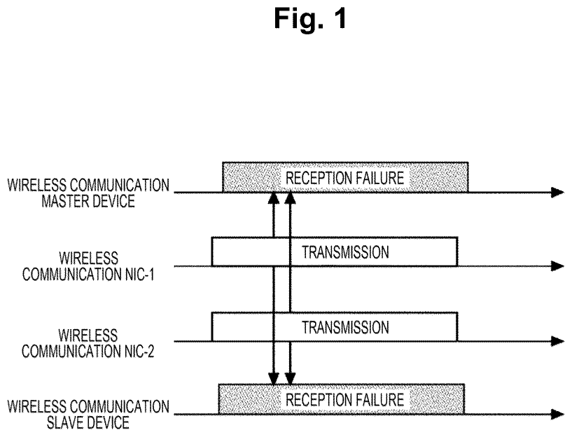

Before description of a first embodiment, problems arising in the conventional method when a plurality of wireless modules perform communication will be described. First, FIG. 1 shows wireless communication timings of a plurality of wireless modules in the same housing according to a first conventional example. The first conventional example where a collision of wireless signals occurs is a case where transmission timings of the plurality of wireless modules included in the same housing of a repeater match by chance.

In an unlicensed frequency band such as a wireless LAN, carrier sensing in a certain time+a random time is generally required. However, in a case where the same random time is set, signals are not detected by mutual carrier sensing, and thus, even when signals are simultaneously transmitted, the signals cannot be recognized. Then, communication proceeds as set, and thus two transmission signals collide in a receiving terminal serving as a destination, and reception fails. Note that carrier sensing is a function of, before a signal is transmitted from its own terminal, confirming whether or not a signal has been transmitted from another terminal during the certain time+the random time.

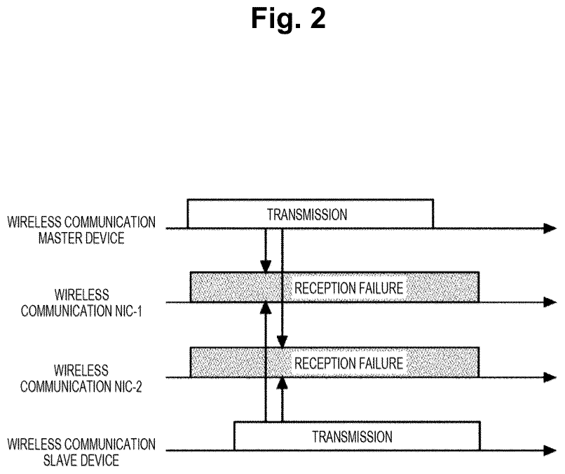

FIG. 2 shows wireless communication timings of a plurality of wireless modules in the same housing according to a second conventional example. The second conventional example where wireless signals collide is an interference problem of hidden terminals. In a case where terminals between which a repeater performs relay are apart from each other, signals of the terminals cannot be detected by carrier sensing thereof. Thus, even when wireless transmissions simultaneously proceed, the signals cannot be recognized. Then, the wireless transmissions proceed, and thus, when the two wireless modules included in the repeater receive the respective signals, the two transmission signals collide, and reception fails.

In order to solve the above problem, an object of the present disclosure is to provide a wireless communication system capable of avoiding a collision of wireless signals by distributing time periods in which traffic is concentrated.

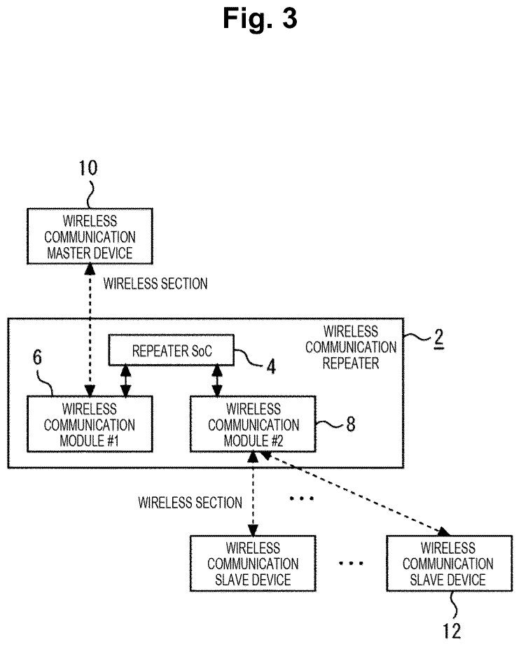

FIG. 3 shows a configuration of a wireless communication system according to the first embodiment of the present disclosure. The wireless communication system includes a wireless communication repeater 2. The wireless communication repeater 2 includes a repeater 4 and is, for example, an SoC (system on chip). The repeater 4 relays wireless communication between wireless communication modules 6 and 8 serving as wireless modules. The wireless communication modules 6 and 8 are, for example, NICs (network interface controllers).

The wireless communication module 6 performs wireless communication with a wireless communication master device 10. The wireless communication module 8 performs wireless communication with a plurality of wireless communication slave devices 12. In a case where the wireless communication system is regarded as a plurality of terminal groups, for example, the wireless communication module 6 and the wireless communication master device 10 are defined as a terminal group 1, and the wireless communication module 8 and the plurality of wireless communication slave devices 12 are defined as a terminal group 2.

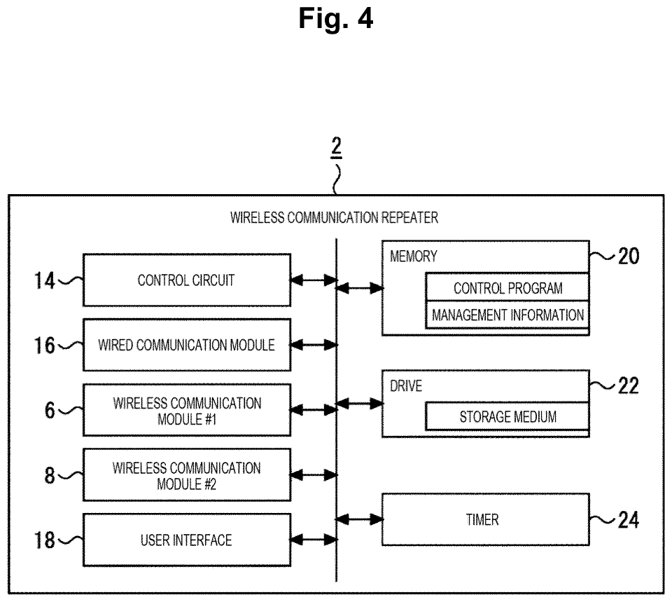

FIG. 4 shows a configuration of the wireless communication repeater of the present disclosure. The wireless communication repeater 2 includes the wireless communication modules 6 and 8 also as shown in FIG. 3. The wireless communication modules 6 and 8 have a function of performing wireless communication, a function of monitoring a total transmission time of wireless transmission, and a function of limiting wireless communication when the total transmission time reaches a certain time. Although three or more wireless communication modules may be included, the present disclosure shows a configuration including two wireless communication modules.

The wireless communication repeater 2 includes a control circuit 14. The control circuit 14 controls an observation period and a start timing by using management information in accordance with a management program included therein.

The wireless communication repeater 2 includes a wired communication module 16. The wired communication module 16 has a function of performing wired communication and is used, for example, when performing wired communication with another repeater. The wireless communication repeater 2 also includes a user interface 18. The user interface 18 is a module used when setting of the wireless communication repeater 2 is changed from the outside and is, for example, a controller operated by a user.

The wireless communication repeater 2 includes a memory 20. The memory 20 stores a control program and the management information. The wireless communication repeater 2 also includes a drive 22. The drive 22 includes a storage medium and stores setting information and the like of the repeater. The wireless communication repeater 2 further includes a timer 24. The timer 24 measures, for example, time related to wireless communication of the repeater.

Note that a control unit included in the device of the present disclosure can also be implemented by a computer and a program, and the program can be recorded in a recording medium or be provided via a network.

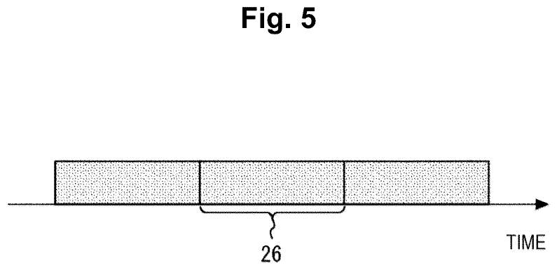

FIG. 5 shows an observation period according to the first embodiment. In the wireless communication modules 6 and 8 according to the first embodiment, a transmission time during a certain observation period 26 is monitored to be equal to or less than a certain time in order to limit the total transmission time of wireless transmission.

The duty limit is a limitation of the total transmission time, which is limited as “the total transmission time within 360 seconds per hour” by law. For example, the duty limit is set to 10% in the 920 MHz band in Japan, and thus the total transmission time of a wireless communication terminal is limited to 360 seconds or less per hour. Note that the duty limit is imposed on the premise that the wireless communication terminal has a function of monitoring and limiting the total transmission time in the band.

In order to comply with the duty limit, it is more realistic to monitor the transmission time in units of observation periods that can be implemented in the terminal than to monitor the total transmission time in one hour. For example, monitoring is performed such that the total transmission time is equal to or less than 100 msec with respect to the observation period of 1 second, and this monitoring is repeatedly performed. This makes it possible to comply with the duty limit of 10% even for a long period of time such as one hour.

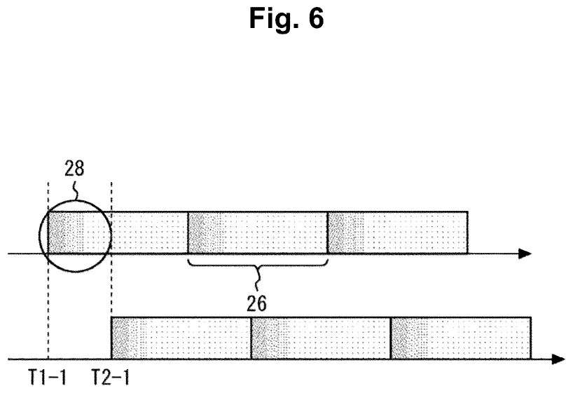

FIG. 6 shows a start timing of observation in the plurality of wireless modules according to the first embodiment. Here, FIG. 6 shows a case where, when two wireless modules are used, the observation period 26 is provided for the purpose of limiting the total transmission time in order to comply with the duty limit.

As means for solving the problem in the present disclosure, in order to avoid a collision of wireless signals, a start timing of the observation period 26 is shifted between the plurality of wireless modules in the same housing. Specifically, the control circuit 14 determines how much the start timing of the observation period 26 is shifted and transmits the shift to the wireless communication modules 6 and 8, thereby controlling the start timing of the observation period 26. In a case where a traffic load is heavy with respect to the duty limit, it is considered that transmission is concentrated from a start timing of a period in which the total transmission time is monitored to a time limit defined by the duty. By using the above point, the start timing is shifted, and thus a time period in which transmission is concentrated is distributed for each terminal or terminal group.

The reason why the traffic load can be distributed will be described in more detail. Although traffic transmission is originally desired to be constantly performed, the traffic transmission can be performed only for a limited proportion of time in the observation period 26 due to the duty limit. As a result, the traffic is transmitted as much as possible immediately after the start timing of the observation period 26, and the transmission is interrupted when the time limit is exceeded. This state is traffic concentration 28 in FIG. 6. When the start timing of the observation period 26 is shifted, the traffic concentration 28 can be distributed, and thus a signal collision between the wireless modules can be avoided.

For example, in a case where the observation period is set to 1 second, the start timing of the observation period in each wireless module is shifted by 500 msec. For example, in a case where the observation period 26 is 1 second in the case of FIG. 6, a time from T1-1 to T2-1 is set to 500 msec. In a case where the duty limit is 10%, the total transmission time is limited to 100 msec. Even in consideration of an overhead for access control, the traffic concentration 28 having a high traffic load continues for approximately 150 msec from the start timing. That is, the total transmission time is used up in the period, and transmission cannot be performed for remaining 850 msec. Therefore, even when the observation period of another wireless module or terminal group is started at the timing shifted by 500 msec, wireless signals do not collide.

Alternatively, the start timing of the observation period 26 is matched in a terminal group including terminals communicating with the respective wireless modules, whereas the start timing of the observation period 26 is shifted between different terminal groups. This makes it possible to distribute the time periods of the traffic concentration 28 even in a relationship of hidden terminals, thereby avoiding a signal collision between the terminal groups.

### REFERENCE SIGNS LIST

14 Control circuit
26 Observation period

1. A wireless communication device comprising:
a plurality of wireless modules; and
a control circuit, wherein:
the wireless modules perform
wireless communication,
monitoring a total transmission time of the wireless communication per certain observation period, and
limiting the wireless communication when the total transmission time reaches a certain time; and
the control circuit performs determining a different start timing of the observation period for each wireless module.

2. The wireless communication device according to claim 1, wherein:
the wireless modules include two wireless modules; and
the start timing of the observation period of one wireless module is a timing at which ½ of the observation period of the other wireless module has elapsed.

3. A wireless communication method wherein:
a plurality of wireless modules performs
performing wireless communication,
monitoring a total transmission time of the wireless communication per certain observation period, and
limiting the wireless communication when the total transmission time reaches a certain time; and
the control circuit performs determining a start timing of the observation period.

4. The wireless communication method according to claim 3, wherein:
the wireless modules include two wireless modules; and
the start timing of the observation period of one wireless module is a timing at which ½ of the observation period of the other wireless module has elapsed.

5. The wireless communication method according to claim 3, wherein
the start timing of the observation period is determined to be different for each wireless module included in a same terminal group.

6. A wireless communication system comprising:
a plurality of wireless module circuitry that performs wireless communication,
monitors a total transmission time of the wireless communication per certain observation period, and
limits the wireless communication when the total transmission time reaches a certain time; and
control circuitry that determines a start timing of the observation period.

7. The wireless communication system according to claim 6, wherein:
the wireless module circuitry includes two wireless module circuitry; and
the start timing of the observation period of one wireless module circuitry is a timing at which ½ of the observation period of the other wireless module circuitry has elapsed.

8. The wireless communication system according to claim 6, wherein
the start timing of the observation period is determined to be different for each wireless module circuitry included in a same terminal group.
